(19) United States
(12) Patent Application Publication
(10) Pub. No.: US 2012/0240243 A1
(43) Pub. Date: Sep. 20, 2012

(54) SYSTEM, METHOD, AND COMPUTER PROGRAM PRODUCT FOR CREATION, TRANSMISSION, AND TRACKING OF ELECTRONIC DOCUMENT

(75) Inventor: Mark Allardyce, Lymm (GB)

(73) Assignee: Yasden - Comercio International E Servicos, Sociedade Unipessoal LDA, Madeira (PT)

(21) Appl. No.: 13/419,526

(22) Filed: Mar. 14, 2012

Related U.S. Application Data
(60) Provisional application No. 61/453,188, filed on Mar. 16, 2011.

(51) Int. Cl. G06F 21/24

(52) U.S. Cl. 726/28

(57) ABSTRACT

A system for creating and delivering a locked electronic document in a computing environment includes a computer readable system memory comprising at least one program module, a bus coupled to the computer readable system memory, a processor coupled to the bus, and program instructions stored on the system memory for execution by the processor. The program instructions create a lead sheet having a unique embedded identifier, add a payload to the lead sheet to form the electronic package, add a blanking layer to the electronic package to obscure the payload from view of a recipient, send the electronic package in the computing environment to a designated recipient, validate the designated recipient's identity, and remove the blanking layer in response to validating the designated recipient's identity, thereby allowing the recipient to view the payload.

### CROSS REFERENCE TO RELATED APPLICATION

Reference is made to and this application claims priority from and the benefit of U.S. Provisional Application Ser. No. 61/453,188, filed Mar. 16, 2011, entitled “Electronic Document Tracking”, which application is incorporated herein in its entirety by reference.

### FIELD OF THE INVENTION

This disclosure relates generally to secure electronic documents and, more specifically, to creating, delivering, and tracking secure electronic documents.

### BACKGROUND OF THE INVENTION

Securely transmitting documents over the Internet is of great importance to many users. Encryption methods are available to provide a measure of security, but if the document falls into the wrong hands, the encryption can be cracked and the sender may never know the document was intercepted. In addition, the original recipient of a document may forward it to other recipients without the knowledge of the original sender. Thus, the chain of custody for the document can be broken, and the sender is unaware of how many copies of the electronic document have been made, or to whom they were sent.

### SUMMARY OF THE INVENTION

In accordance with one aspect of the disclosure, systems and techniques relating to the creation and tracking of locked electronic documents are described. The disclosed methods for creating these documents allows various user-defined levels of lockdown and control, and allows the document to be tracked throughout its lifecycle.

In one embodiment of the invention, a locked electronic document is created with content blanked out, and can only be read when appropriate validation measures are input by the recipient. The same opening process can be utilized to enforce a sender's terms and conditions of use of the document, and the information contained therein by making the validation measures an ‘acceptance of terms.’ The opening process may also allow for the document to be GeoTagged via recipient interaction with the document. In one aspect, the GeoTagging uses a 3rd party GeoIP database to present the geographical location of the IP address that opened the locked document. The accuracy of the location is dependent on the accuracy of the 3rd party provider chosen. The above ensures that when the sender's confidential document is received its terms have been accepted and its location of opening tracked before the recipient can see any of the important detail.

In another aspect of the disclosure, secure, or locked, electronic documents are created via user interaction with a web application. Once created, the document can be distributed via email using the web application. Recipient interaction with the document is logged via the web application.

In one aspect of the disclosure, a system for creating and delivering a locked electronic document in a computing environment includes a computer readable system memory comprising at least one program module, a bus coupled to the computer readable system memory, a processor coupled to the bus, and program instructions stored on the system memory for execution by the processor. The program instructions create a lead sheet having a unique embedded identifier, add a payload to the lead sheet to form the electronic package, add a blanking layer to the electronic package to obscure the payload from view of a recipient, send the electronic package in the computing environment to a designated recipient, validate the designated recipient's identity, and remove the blanking layer in response to validating the designated recipient's identity, thereby allowing the recipient to view the payload.

In another aspect of the disclosure, a method for creating and sending by a sender a locked electronic document and delivering the locked electronic document to a recipient in a computing environment includes the steps of creating a locked electronic document comprising a lead sheet and a payload. The lead sheet has a unique identifier for the locked electronic document. The method further includes the steps of adding a blanking layer to obscure the payload from view of the recipient, sending the electronic package in the computing environment to a designated recipient, validating the recipient's identity to assure the recipient of the electronic package is the designated recipient, and removing the blanking layer in response to validating the recipient's identity, thereby allowing the recipient to view the payload,

In another aspect of the disclosure, a computer program product for creating and delivering a locked electronic document in a computing environment includes a computer readable storage device having computer readable program instructions embodied therewith. The program instructions are configured to create a lead sheet having a unique embedded identifier, add a payload to the lead sheet to form the locked electronic document, add a blanking layer to the locked electronic document to obscure the payload from view of a recipient, send the electronic package in the computing environment to a designated recipient, validate the designated recipient's identity, remove the blanking layer in response to validating the designated recipient's identity, thereby allowing the recipient to view the payload, and track the payload by acquiring an Internet Protocol address of the recipient and correlating the Internet Protocol address to a geographic region.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a cloud computing node, according to one embodiment of the invention;

FIG. 2 depicts a cloud computing environment, according to one embodiment of the invention;

FIG. 3 depicts a cloud computing environment, according to another embodiment of the invention;

FIG. 4 depicts a flow diagram of a method for creating and delivering a locked electronic document in a computing environment, in accordance with one embodiment of the present invention;

FIG. 5 depicts an exemplary graphic user interface (GUI) for a computer program application according to one embodiment of the invention;

FIG. 6 depicts an exemplary graphic illustration of a locked electronic document according to one embodiment of the invention;

FIG. 7 depicts an exemplary graphic user interface for generating a lead sheet from the GUI of FIG. 5, according to one embodiment of the invention;

FIG. 8A depicts an exemplary graphic illustration of a lead sheet generated by the GUI of FIG. 7, according to one embodiment of the invention;

FIG. 8B depicts an exemplary graphic illustration of a payload generated by the GUI of FIG. 7, according to one embodiment of the invention;

FIG. 9 depicts a table of computer file formats supported by the computer program application of FIG. 5;

FIG. 10 depicts an exemplary graphic illustration of a blanking process for the computer program application of FIG. 5, according to one embodiment of the invention;

FIG. 11 depicts an exemplary graphic user interface of a shipment form generated by the GUI of FIG. 5, according to one embodiment of the invention;

FIG. 12 depicts an exemplary graphic user interface of a shipment form generated by the GUI of FIG. 5, according to another embodiment of the invention;

FIG. 13 depicts an exemplary graphic user interface of a tracking form generated by the GUI of FIG. 5, according to one embodiment of the invention;

FIG. 14 depicts an alternate graphic user interface and graphic illustration of a tracking form for the computer program application of FIG. 5, according to one embodiment of the invention; and

FIG. 15 depicts yet another alternate graphic user interface and graphic illustration of a tracking form for the computer program application of FIG. 5, according to one embodiment of the invention.

### DETAILED DESCRIPTION OF THE INVENTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed. For example, one or more of the steps and functions disclosed and contemplated herein can be implemented on systems constituted by a plurality of devices (e.g., host computer, interface, reader, and printer) or to a single device.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least five deployment models.

Characteristics may be described as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

Private Cloud Rentals:

A cloud computing environment is service oriented with a focus on statelessness, low coupling, modularity, and semantic interoperability. At the heart of cloud computing is an infrastructure comprising a network of interconnected nodes.

As noted above, embodiments of the invention disclosed herein provide a solution for creation, shipping, and tracking of locked electronic documents within a Cloud computing environment. The process for creating these documents allows various user-defined levels of lockdown and control and allows the document to be tracked throughout its lifecycle.

Typically, the creation, shipping, and tracking of locked electronic documents is implemented between a user's local computing device and the storage Cloud. Through the use of a browser plug-in (or the like), the documents can be assembled, packaged, securely shipped, and tracked throughout its lifetime.

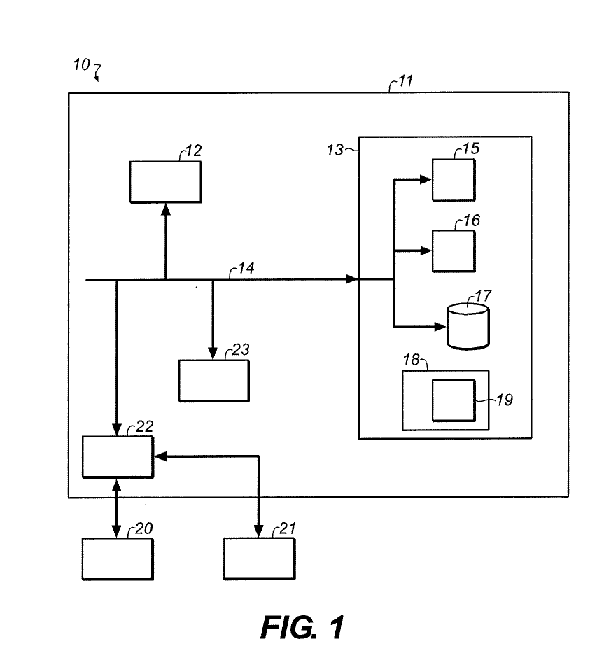

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 11, which is operational with numerous other general purpose or special purpose computing system environments or configurations. Examples of well-known computing systems, environments, and/or configurations that may be suitable for use with computer system/server 11 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 11 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 11 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 11 in cloud computing node 10 is shown in the form of a general-purpose computing device. The components of computer system/server 11 may include, but are not limited to, one or more processors 12 or processing units, a system memory 13 and a bus 14 that couples various system components including system memory 13 to processor 12.

Bus 14 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 11 typically includes a variety of computer system readable media. Such media may be any available media that is accessible by computer system/server 11, and it includes both volatile and non-volatile media, removable and non-removable media.

System memory 13 can include computer system readable media in the form of volatile memory, such as random access memory 15 (RAM) and/or cache memory 16. Computer system/server 11 may further include other removable/non-removable, volatile/non-volatile computer system storage media. By way of example only, storage system 17 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces. As will be further depicted and described below, memory 13 may include at least one program product having a set (e.g., at least one) of program modules that are configured to carry out the functions of embodiments of the invention.

Program/utility 18, having a set (at least one) of program modules 19, may be stored in memory 13 by way of example, and not limitation, as well as an operating system, one or more application programs, other program modules, and program data. Each of the operating system, one or more application programs, other program modules, and program data or some combination thereof, may include an implementation of a networking environment. Program modules 19 generally carry out the functions and/or methodologies of embodiments of the invention as described herein.

Computer system/server 11 may also communicate with one or more external devices 20 such as a keyboard, a pointing device, a display 21, etc.: one or more devices that enable a user to interact with computer system/server 11; and/or any devices (e.g., network card, modem, etc.) that enable computer system/server 11 to communicate with one or more other computing devices. Such communication can occur via Input/Output (I/O) interfaces 22. Still yet, computer system/server 11 can communicate with one or more networks such as a local area network (LAN), a general wide area network (WAN), and/or a public network (e.g., the Internet) via network adapter 23. As depicted, network adapter 23 communicates with the other components of computer system/server 11 via bus 14. It should be understood that although not shown, other hardware and/or software components could be used in conjunction with computer system/server 11. Examples, include, but are not limited to: microcode, device drivers, redundant processing units, external disk drive arrays, RAID systems, tape drives, and data archival storage systems, etc.

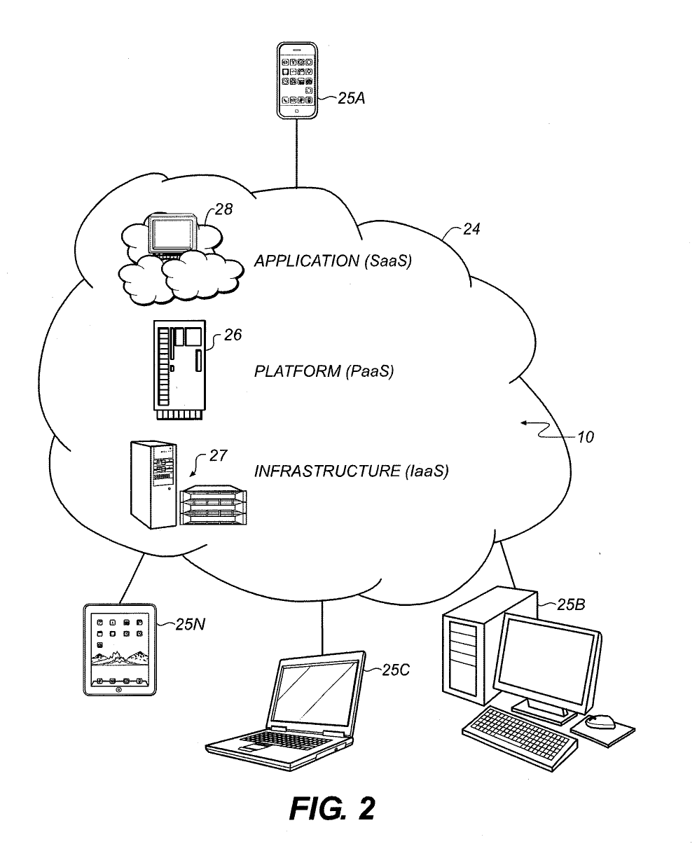

Referring now to FIG. 2, illustrative cloud computing environment 24 is depicted. In the illustrated embodiment, cloud computing environment 24 includes one or more cloud computing nodes 10 with which local computing devices 25 used by cloud consumers, such as, for example, cellular or “smart” telephone 25a, desktop computer 25b, laptop computer 25c, and/or tablet computer system 25n may communicate. Nodes 10 may communicate with one another. Although not shown, they may be grouped physically or virtually, in one or more networks, such as Private, Community, Public, Hybrid, or Rental clouds as described hereinabove, or a combination thereof. This allows cloud computing environment 24 to offer infrastructure, platforms and/or software as services for which a cloud consumer does not need to maintain resources on a local computing device. It is understood that the types of computing devices 25a-n shown in FIG. 2 are intended to be illustrative only and that computing nodes 10 and cloud computing environment 24 can communicate with any type of computerized device over any type of network and/or network addressable connection (e.g., using a web browser).

The cloud computing environment 24 provides hardware and software components. It should be understood in advance that the components and functions shown in FIG. 2 are intended to be illustrative only and embodiments of the invention are not limited thereto. Examples of hardware components include mainframes, servers, Reduced Instruction Set Computer architecture based (RISC) servers, storage devices, networks, and networking components. Examples of software components include network application server software, application server software, and database software.

The cloud computing environment 24 may further provide virtual entities 26 such as virtual servers, virtual storage, virtual networks, including virtual private networks, virtual applications and operating systems, and virtual clients.

In addition, the cloud computing environment 24 may provide management functions 27 such as resource provisioning for dynamic procurement of computing resources and other resources that are utilized to perform tasks within the cloud computing environment. Management functions 27 may include metering and pricing to provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. A user portal 28 such as a web application site provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

The cloud computing environment 24 provides functionality for which the cloud computing environment may be utilized. For example, functions which may be provided include software development and lifecycle management, data analytics processing, transaction processing, and secure electronic document creation, sending, and tracking.

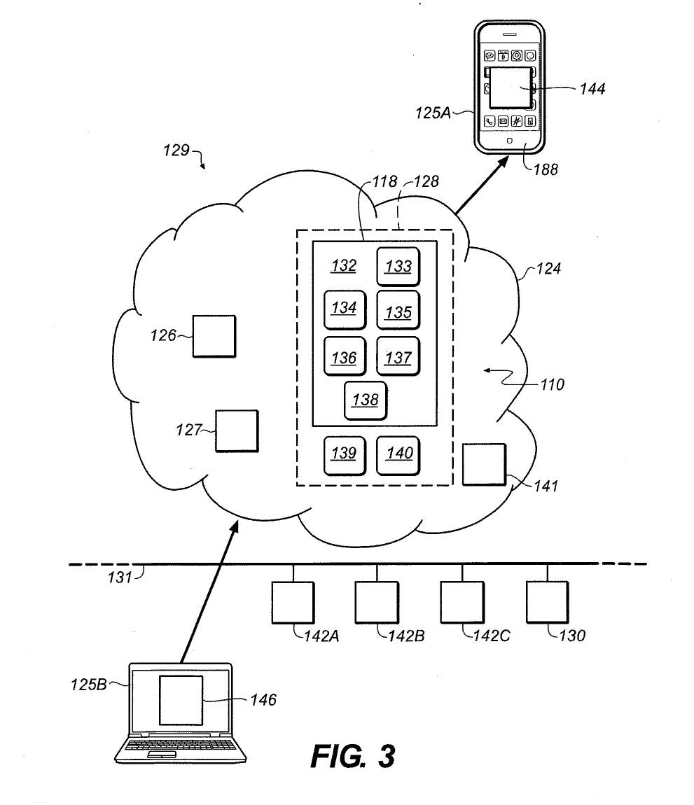

Turning to FIG. 3, wherein like numbers indicate like elements from FIGS. 1 and 2, a system 129 for creating, delivering, and tracking a locked electronic document in a cloud computing environment 124 is depicted according to one embodiment of the current invention. The cloud computing environment 124 includes a web application site 128 that can be accessed only by subscribers. Subscribers log on to the web application site 128 from a local computing device 125, such as a laptop computer, to create and distribute the secure documents.

In one embodiment, the web application site 128 is hosted by Amazon Web Services' Elastic Compute Cloud (EC2) component. The Amazon EC2 component provides resizable compute capacity in the Amazon cloud. An application owner can define their virtual Amazon EC2 environment with the operating system, services, databases, and application platform stack required for their hosted application. Amazon EC2 then provides a full management console and Application Program Interfaces (APIs) to manage the particular compute resources. In one example, the system 129 utilizes one Small Instance with 1.7 GB of memory, one EC2 Compute Unit (e.g., one virtual core with one EC2 Compute Unit), 160 GB of local instance storage, 32-bit platform running Microsoft Windows Server® 2008r3. In one embodiment of the invention that will be referred to extensively herein, the hosted application 118 on the web application site 128 allows a user to create, deliver, and track a locked electronic document. In one example, the hosted application 118 is the ConfiTrack™ web-based confidential document carrier.

The system 129 may further include a public web site component 130 that is accessible by any user of the Internet 131. The public web site 130 can include background information, sales materials, marketing information, and pricing for the company offering the locked electronic document services. In one example, the public web site 130 is hosted by an Apache web server (hosted by http://www.names.co.uk).

The web application site 128 furthers include an integrated development platform 132 that provides a rapid application development environment. In one example, the integrated development platform 132 is the 4D program module published by 4D SAS. The 4D software can be installed on the Cloud application site 128 (e.g., the Amazon Cloud EC2 component) and form the basis of the disclosed method and computer program product for creating and delivering a locked electronic document. The 4D program module has within it the following components that can be used in providing embodiments of the invention disclosed herein: an HTTP web server 133 to serve web pages for subscribed members; a 4D Simple Object Access Protocol (SOAP) server 134, which publishes SOAP methods accessible by SOAP clients. In one example described below, a SOAP method is called by the ‘Accept’ button on the lead sheet to check for authorization to unlock a document. Further components that can be used in providing embodiments of the invention include: a 4D database 135 where all the information is held in relation to subscribers, shipments, document tracking, etc.; and a 4D Business Logic Layer (4GL Language) 136, which is used to handle all back office tasks like creating PDFs, sending emails, and fulfilling the shipments and maintaining the database environment, for example.

The integrated development platform 132 may further include an Active 4D plug-in 137 for the 4D environment that allows the implementation of 4D code within web pages and also handles and manages web-based user sessions on the server.

The integrated development platform 132 may further include a PDF plug-in 138 for the 4D programming language that allows the user to generate files in Adobe's Portable Document Format (PDF). The plug-in has an extensive command set for programmatically creating text, graphics, images and hypertext objects. The PDF plug-in 138 is comprehensive enough that typical third-party software such as Acrobat Distiller or PDF Writer is not needed. The plug-in 138 is based on established technology, utilizing the powerful PDFlib as its engine. PDFlib is a cross-platform “C” library being developed by PDFlib GmbH in Germany. PDFlib has implementations for many programming languages and is available for a wide variety of platforms.

The web application site 128 may further include a document conversion utility 139. In one example, the OmniFormat program module, available from Software995, can be utilized to allow dynamic conversion of over 75 file formats to PDF documents. Supported formats for conversion to .PDF include HTML, DOC, XLS, WPD, PDF, JPG, GIF, TIF, PNG, PCX, PPT, PS, TXT, Photo CD, FAX and MPEG. Preferably, a suite of inter-related desktop business applications 140, such as Microsoft Office® software, can be installed on the Cloud server 128 in order to enable the document conversion utility 139 to convert Microsoft Word®, Excel® and PowerPoint® documents to PDF.

The cloud computing environment 124 may further include a functionality module 141 or server that incorporates or permits increased functionality in a document. In one embodiment, the Adobe LiveCycle® Reader Extensions ES2 module is utilized to activate features in a .PDF document for use with Adobe Reader, when such features are normally only enabled when using the full licensed Adobe Acrobat product. In one example, the Adobe® LiveCycle® Reader Extensions ES2 module 141 activates the SOAP functionality within PDF documents, allowing them to be opened by Adobe Reader. In another example, the module 141 can be used to apply digital signatures within the Adobe Reader environment.

Program modules operating in the cloud computing environment 124 may also access a third-party web site 142 to perform certain tasks. In one example, a handset detection web site 142A such as www.handsetdetection.com may be used to detect the local computing device 125 (e.g., iPad, mobile phone, etc.) that is connecting to the hosted application 118, and redirect the device to corresponding web pages configured for a variety of screen sizes. This is primarily used when the recipient receives a document delivery on a mobile device that is not configured to open a PDF document. In another example, an authenticated Simple Mail Transfer Protocol (SMTP) mail service 142B such as www.authsmtp.com may be accessed to send all emails originating from the hosted application 118. In yet another example, a third-party web site 142C such as www.hostip.info may be used to detect a user's IP address and provide location information (e.g., country and city). This information can be utilized by an API, such as that offered by the HostIP.Info web site, to Geocode the IP address. In this manner, when a sender or recipient requests a web page from the hosted application 118 or connects to the 4D Soap Server, their IP address can be detected and their geographical location identified.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

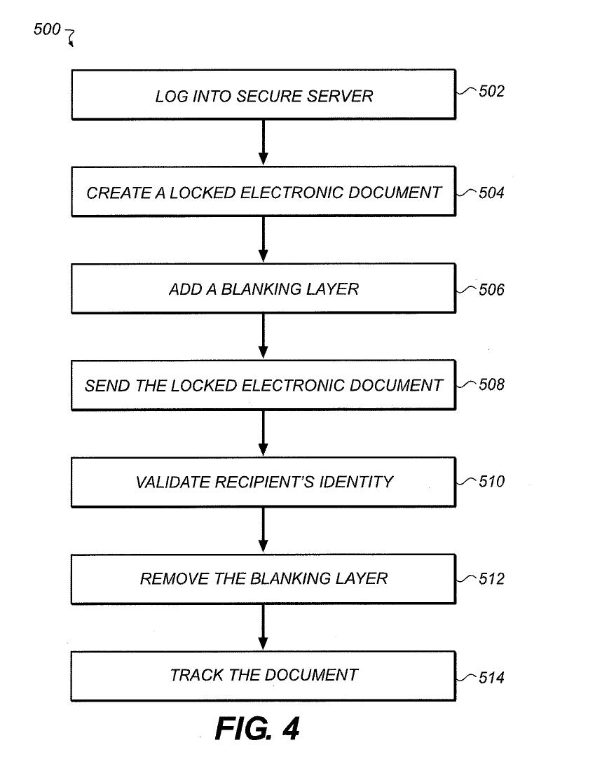

FIG. 4 depicts a flow diagram of a method 500 for creating and delivering a locked electronic document in a computing environment. In one embodiment of the invention, the purpose of the disclosed method 500 is to create a secure document whose contents are blanked out and can only be viewed (e.g., opened) by a recipient when an appropriate action is taken, such as clicking an acknowledgement button on the first page of the locked document once the recipient's identity is validated. The opening process may also be utilized to enforce a sender's terms and conditions of use of the document and the information contained therein by making the acknowledgement button an ‘Acceptance of Terms’ button. The opening process may also allow the document to be GeoTagged via recipient interaction with the document. GeoTagging is the process of adding geographical identification metadata to the document and is a form of geospatial metadata usually consisting of latitude and longitude coordinates. The GeoTagging may use a 3^{rd}-party GeoIP database to present the geographical location (e.g., longitude and latitude) of the IP address that opened the locked document. The accuracy of the location is dependent on the accuracy of the 3^{rd} party provider chosen. The procedure described ensures that when the sender's confidential document is received, its terms have been accepted and its location of opening tracked before the recipient can see any of the important detail.

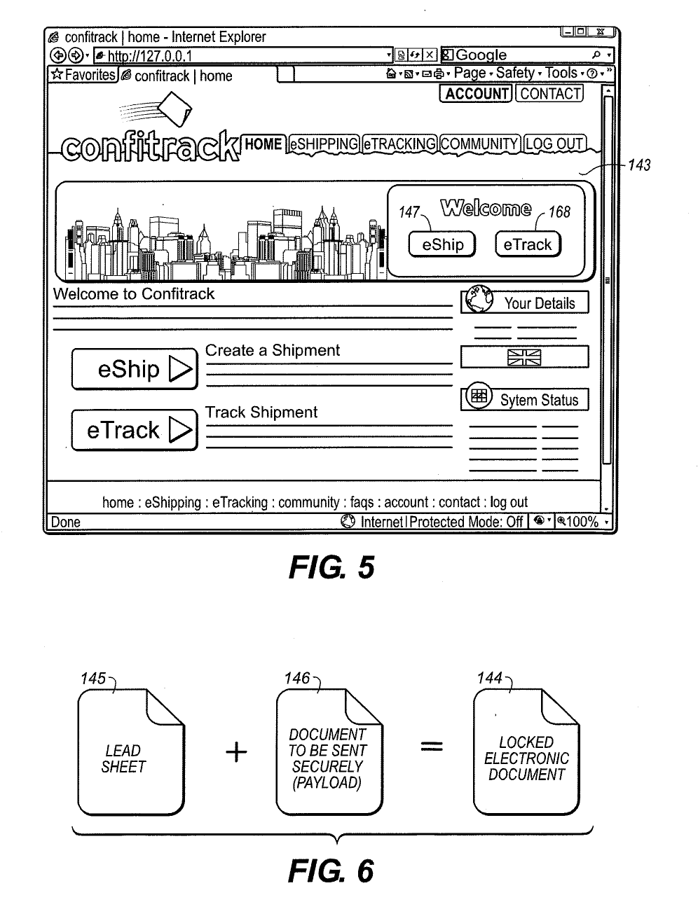

Referring now to FIGS. 4-15, the method 500 can include a step 502 of logging in to a secure server. In one exemplary method step, the sender accesses the hosted application 118 from their local computing device 125, enters a username and password, and logs in to the secure portion of the web site. Upon successful entry, a home screen 143 is displayed, such as that depicted in FIG. 5. Several notable features are present on the home screen 143. In one example, a panel on the right of the screen indicates the current logged on users' IP Address and the Country where this IP Address originates from. This information may be obtained from a third party source such as such as www.hostip.info, as noted above, which is a free service. Other paid services are available that provide a greater degree of accuracy and coverage of IP addresses.

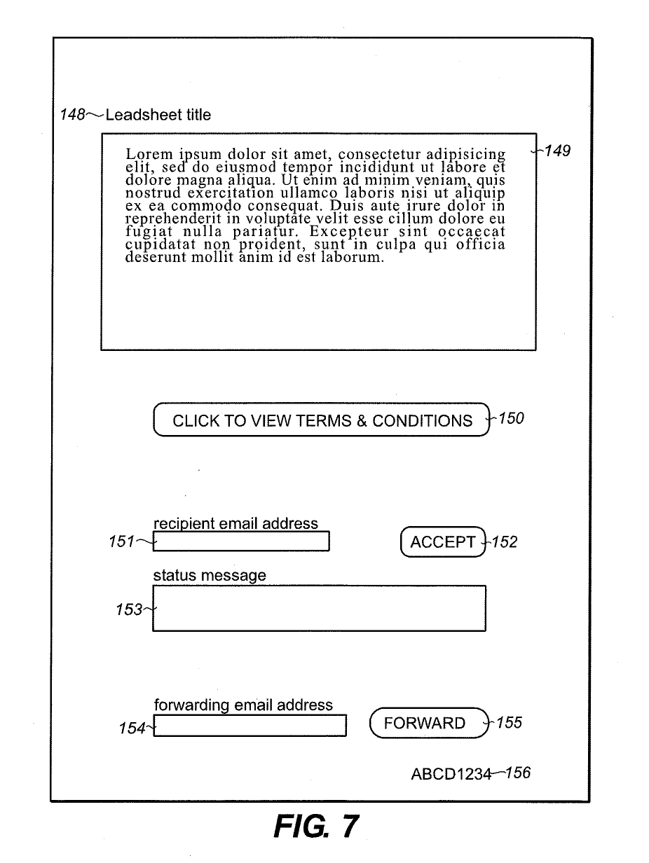

The method 500 includes a step 504 of creating a locked electronic document 144. In one embodiment, the locked electronic document 144 includes a lead sheet 145 and a payload 146 (FIG. 6). In the illustrated embodiment depicted in FIG. 5, the step of creating the lead sheet is initiated by clicking on the ‘eShip’ button 147. The sender may be asked to specify a name for the shipment 148, and a time period for which the shipment may be tracked.

In one embodiment of the invention, a credit system may be utilized to pay for services offered through the web site. In one example, a user may provide monetary funds through a secure portal and receive credits, perhaps on a monthly basis. The credits can be redeemed as services are rendered. For example, a user may be charged 1 credit to upload a payload 146 to the system 129, and 1 credit per month to track the payload.

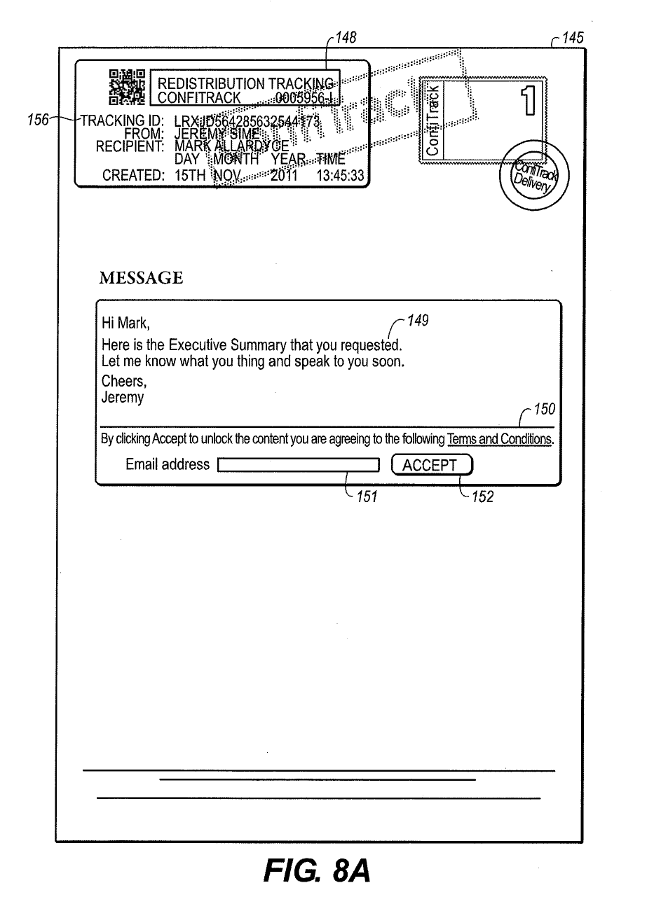

Further in the process of creating the lead sheet, the sender enters the details below and the lead sheet 145 is automatically generated. In one example, as noted with reference to FIG. 7, the elements needed for creation of the lead sheet 145 may include the following:
(a) Lead Sheet Title 148;
(b) Message Box 149, wherein the sender can enter text to personalize the lead sheet;
(c) Terms & Conditions Button 150. The sender may have a standard set of terms and conditions (T&C) that they use in the form of an existing document. The T&C could also exist as a URL to existing online content, for example a web page showing the sender's terms and conditions. If the sender chooses to upload a document as their terms and conditions it is ordinarily text based, e.g., PDF or Microsoft Word but can be any file type. In the illustrated example, the Terms & Conditions button is added to the lead sheet 145, and a hyperlink is added to the Terms & Conditions button that opens either the terms and conditions document or links to existing online content. Standard Terms & Conditions from the application owner can be prepended to the sender's terms and conditions. In this manner, when the recipient clicks on the Accept button, they are accepting the application owner's standard terms and conditions as well as any sender's terms and conditions that have been appended. In another example, if the sender chooses not to upload any of their own terms and conditions, only the application owner's standard terms and conditions will be displayed and it will be these alone that will be accepted.
(d) Enter Recipient Email Address Field 151;
(e) Accept Button 152. When the recipient clicks the Accept button on the lead sheet 145, a request to open the document is sent to the hosted application 118. The rest of the document will be unlocked only if the server responds to the request positively.
(f) Status Message 153. This is a text area that displays a message from the hosted application 118 in response to the clicking of the Accept button. If the server grants permission to ‘unblank’ the rest of the document, the following Status Message 153 displays: “Document unlocked: tracking commenced.” If the hosted application 118 denies permission, the following Status Message 153 displays: “You are not authorized to view this document.” Other messages can be generated depending on specific situations.
(g) Enter Forwarding Email Address Field 154—an optional field to fill in an email address of an additional party to which the recipient wishes to forward the document;
(h) “Forward” Button 155—Upon clicking the ‘Forward’ button, the hosted application 118 is contacted and a new document is created and an email sent to the email address that has been entered with a document attached;
(i) Unique Tracking ID 156—Every locked electronic document 144 created has a Unique Tracking ID appended to the bottom of the document.

Other elements can be appended to the lead sheet 145 and are contemplated within the scope of the present invention. For example, a ‘Free Trial Button’ can be added that has a hyperlink that, when clicked, takes the recipient to a page on the hosted application 118 where they can sign up for a free trial of the locked electronic document delivery service. In another example, various areas of the lead sheet 145 can be designated for the positioning of graphic or textual advertisements or sponsorship messages, such as real estate. Each of these areas can be individually hyperlinked to take the user to the designated pages on the advertisers or sponsors websites.

Further information regarding the lead sheet or other existing lead sheets belonging to the sender may be displayed on web pages.

When the sender elects to save the lead sheet 145, by clicking a ‘Save’ button in one example, a CreateLeadSheet method can be invoked on the hosted application 118 which creates the lead sheet. Exemplary code or program instructions for this method could be:

```
    CreateLeadSheet(title;messagetext;UniqueID;SerialNumber)
The method is passed the Lead Sheet title, Lead Sheet message, a
uniqueID generated by the server and a serial number generated by the
server.
    OutputFileName:=”C:\ct\pdfbin\”+UniqueID+″NDA.pdf″
A variable containing a unique name for the Lead Sheet we are about to
create is assigned, e.g. “1236NDA.pdf” including the path to where the
document will be created, e.g. the Lead Sheet will be created in a folder
called ‘pdfbin’ in the ‘ct’ folder on the ‘C’ drive.
Initialise a new PDF object and document
    PDF New Object
    PDF New Document (OutputFileName)
Load the Lead Sheet Header into a variable called Header. Header.pdf is a
pre-existing PDF document that contains the header detail of the Lead
Sheet. (see next section)
    PDF Open PDI Document (”C:\ct\pdfbin\header.pdf″)
    Header:= PDF Open PDI Page
Load the Lead Sheet Footer into a variable called Footer. Footer.pdf is a
pre-existing PDF document that contains the footer detail of the Lead
Sheet. (see next section)
    PDF Open PDI Document (”C:\ct\pdfbin\footer.pdf″)
    Footer:= PDF Open PDI Page
Load the Lead Sheet Footer with Authorised Forwarding Panel into a
variable called AFPFooter. AFPFooter.pdf is a pre-existing PDF document
that contains the footer detail of the Lead Sheet. (see next section)
    PDF Open PDI Document (”C:\ct\pdfbin\afpfooter.pdf″)
    AFPFooter:= PDF Open PDI Page
Load the Blank Footer with into a variable called BlankFooter.
BlankFooter.pdf is a pre-existing PDF document that contains the footer
detail of the Lead Sheet but contains no buttons. It is used if there is more
than one page in the Lead Sheet (see next section)
    PDF Open PDI Document
    (”C:\ct\pdfbin\blankfooter.pdf″)
    BlankFooter:= PDF Open PDI Page
Start creating the Lead Sheet. Fill in the info fields for the PDF document.
Set the PDF Creator field to be the Serial Number, Author Field to be the
Current Machine Owner and the Title Field to be “NDA”
    PDF Set Info (Creator Field=UniqueID)
    PDF Set Info (Author Field=Current machine owner)
    PDF Set Info (PDF Title Field ;″NDA″)
Setup formatting instructions for the Lead Sheet title and message text
    Lead Sheet title format = Helvetica-Bold fontsize=24
    Lead Sheet message format = Helvetica-Bold
    fontsize=14
Combine the Lead Sheet title and Lead Sheet message along with their
formatting into one text variable called TextFlow and process TextFlow to
create a text flow. This text flow can them be spanned over several pages
and the appropriate headers and footers inserted.
    PDF Create Text Flow (TextFlow)
Loop and create PDF pages until the Lead Sheet title and Lead Sheet
message are contained on one or more PDF pages. Insert headers on each
page.
    While (TextFlow is not fitted completely on page)
Create a new A4 page
    PDF Begin Page (A4 Page Width ;A4 Page Height)
Add the header to the top of the page
    PDF Fit PDI Page (Header;0;262;)
Draw the text into the message textbox on the Lead Sheet
    PDF Fit Text Flow (TextFlow;50;275;Page Width-
    50;Page Height-250)
Suspend the page so that we can later number them
    PDF Suspend Page
Increment a page counter to count the total number of pages
    TotalNumberOfPages:= TotalNumberOfPages +1
    End while
This is the end of the loop. At this point we have created n number of
pages that contain the Lead Sheet title and Lead Sheet message. We now
close the TextFlow.
    PDF Close Text Flow (TextFlow)
We now number the pages and add the appropriate footer to the
document
Load the Helvetica font
    PDF Load Font (PDF Helvetica Font)
Loop around the PDF pages and add the appropriate footers
    For (PageNumber;1;TotalNumberOfPages)
Resume the suspended PDF page
    PDF Resume Page (Counter)
    If (This is the last page)
        If(sender has included Authorised Forwarding)
Include the footer with the Authorized Forwarding Panel on
            PDF Fit PDI Page (AFPFooter;0;0)
        Else
Include the footer without the Authorised Forwarding Panel on
                PDF Fit PDI Page (Footer;0;0)
              End if
        Else
    This is not the last page so add the blank footer
            PDF Fit PDI Page (BlankFooter;0;0)
        End if
Add current date and time page numbers and serial number
            PageDetails:=Current date+″ : ″Current
            time+″ : Page : ″+PageNumber+″ of
            ″+TotalNumberOfPages
            PDF Fit Text Line
            (PageDetails;110;10;″position={center
        bottom}″)
            PDF Fit Text Line (SerialNumber;483;25)
        PDF End Page
    End if
        End for
Close the PDF document
    PDF Close Document
Delete the instance of the PDF object in memory
    PDF Delete Object
The Lead Sheet PDF is now created in the pdfbin folder on the server
```

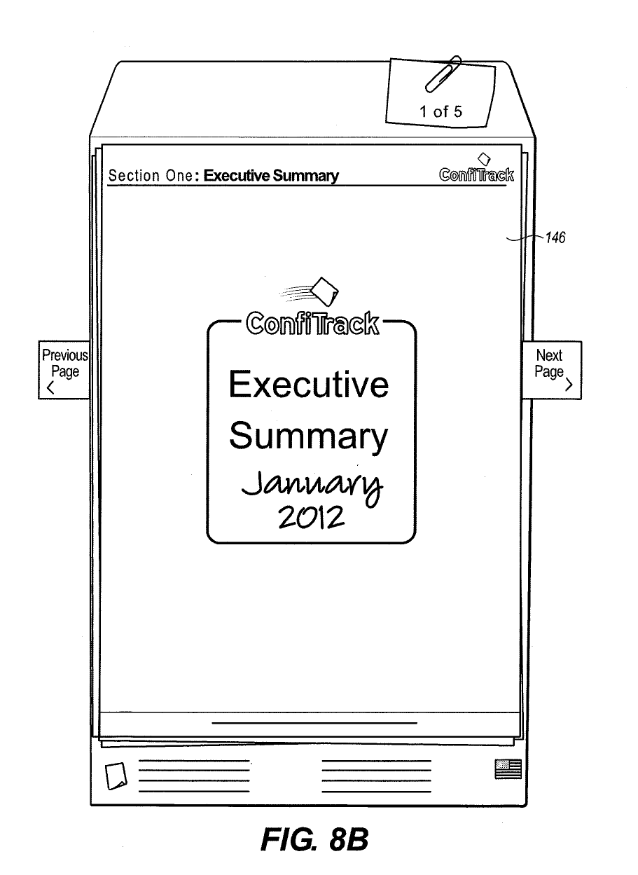

FIGS. 8A and 8B depict an exemplary graphic illustration of a locked electronic document 144 according to one embodiment of the invention. The locked electronic document 144 comprises a lead sheet 145 (FIG. 8A) and a payload 146 (FIG. 8B).

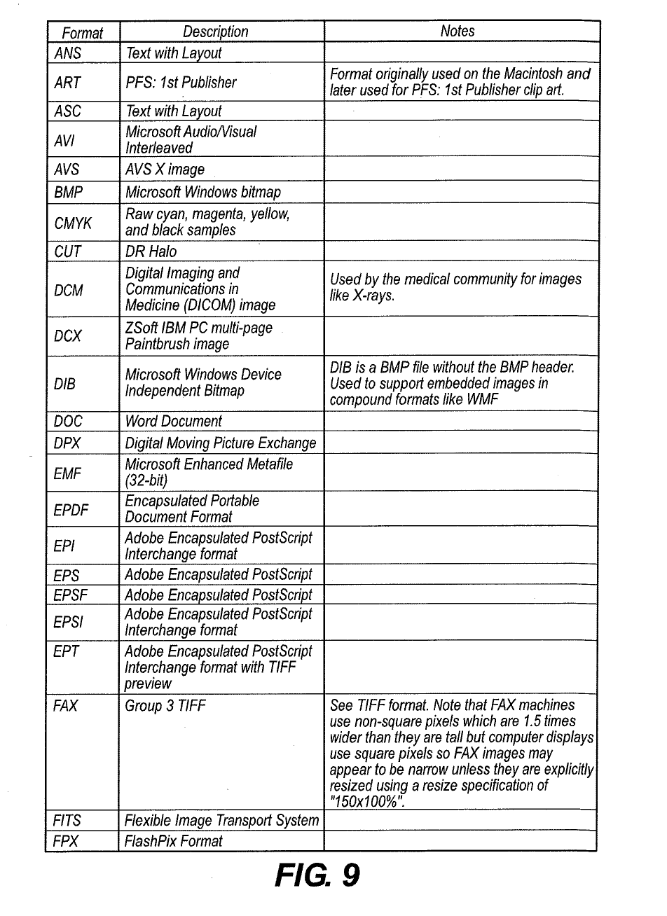

As noted above, the locked electronic document 144 includes the lead sheet 145 and the payload 146. The payload 146, which is the primary document the sender wishes the recipient to receive, can be selected from a variety of file formats. As used herein, the term “document” is not intended to limit the payload 146 to document file formats. Rather, the term “document” refers to any type of media including graphics, pictures, or voice, and is not intended to limit the scope of the invention. A non-exhaustive grouping of file formats envisioned for use with the current invention include: archived and compressed; computer-aided design (CAD); database files; desktop publishing; geographic information such as GeoTIFF; raster, vector, and 3D graphics files; object code, source code, executable files, shared and dynamically-linked libraries; personal information manager files such Microsoft Outlook files; presentation files; scripts; sound and music; spreadsheet; video, including editing and game formats; virtual machines including PC, server, and players; and web page formats. FIG. 9 presents an exemplary and non-limiting table of currently supported formats for the payload 146.

Accordingly, the step 504 of creating the locked electronic document 144 further includes securely uploading the payload 146 from the local computing device 125 to the hosted application 118. In one embodiment, the web application program instructions can provide a graphical user interface to assist in the upload process. In addition to uploading the document as the payload, the sender can also specify URLs to be contained within the payload. In one example, the URL could be a link to a streaming movie, a music track, a website, or any online resource. The upload program module may be configured to generate a plain or graphical page with a button, or a series of buttons, with hyperlinks that launch streaming movies, music tracks, or any other specified online resource. The buttons with hyperlinks may be created within the payload of the document.

In one embodiment of the invention, once the payload document 146 is selected and uploaded, it is saved in its original format and also converted to .PDF format (unless the document was already a .PDF, in which case there is no need for the conversion). The first step in the process to create the PDF from the uploaded document is to invoke the following exemplary method, which may be configured to execute once the ‘Save’ button has been clicked, for example:

```
On clicking ‘Save’ an Active4D script is executed which tests if the
uploaded document is a PDF. In the example below it is assumed
the document is a Word document called ‘test.doc’ which is three
pages long.
    if(The uploaded document is not a PDF)
Upload the file to a folder called ‘temp’
        copy upload(“C:/ct/temp/test.doc”)
A server process watches the ‘temp’ folder and makes a copy of the
uploaded file. It moves one copy to a folder called ‘watchedPDF’
and one to a folder called ‘originalFILES’
    else (if the uploaded document is a PDF)
Copy the PDF document to a folder called ‘converted’
        copy upload(“C:/ct/converted/doc.pdf”)
    end if
There are two instances of Omniformat running on the server.
Instance 1 watches the ‘watchedPDF’ folder and converts any file
into a PDF and moves it to a folder called ‘converted’
A server process watches the ‘converted’ folder and makes a copy of
the PDF. It moves one PDF to a folder called ‘omniformatPDF’ and
one to a folder called ‘watchedPNG’.
Instance 2 of Omniformat watches the ‘watchedPNG’ folder. It
converts each page of any PDF dropped into that folder into a PNG
image and once processed moves these to a folder called
‘omniformatPNG’
The output from this process for the ‘test.doc’ would be :
  • Copy of the original file in Word format (test.doc) in the folder
  ‘originalFILES’
  • A PDF version (test.pdf) in the folder ‘omniformatPDF’
  • Three PNG images (one per page) in the folder
  ‘omniformatPNG’ (test001.png, test002.png, test003.png)
There is a process (PDF_Rename) that runs at regular intervals on
the server which checks the ‘omniformatPDF’ folder for PDF files. It
moves any PDFs in that folder to a folder called ‘pdfbin’ giving them
a unique identifying number and a suffix of DOC, e.g. 26546DOC.pdf
```

Once the payload 146 has been converted to PDF format, the lead sheet document 145 is prepended to the payload document 146 to create one document. At this stage, the payload document 146 has a process 506 applied which blanks out the contents of the document. The “blanking” process 506 is achieved by creating the payload document 146 as a series of layers. The bottom layer is the payload content, that is, the content that needs to be obscured until the recipient has entered valid criteria (unlock code and valid email address). The next layer that is created is an opaque white layer, or blanking layer 157 that overlays the payload layer. In one embodiment the default state for the blanking layer 157 is opaque white, however, this can be changed to be any color, or to show watermarks, or even be used as advertising, or real estate sponsorship, for example. In one example, images and hyperlinks can be positioned on these blanking layers to impart information/advertising/sponsorship messages and also allow recipients to be directed to online resources (e.g., websites, streaming media) by clicking hyperlinks before the Accept button is clicked and the document payload revealed. In another example, these layers can have a visibility attribute applied. The default state of the document is to make the payload layer not visible and the blanking layer 157 visible. In this way, the payload portion of the document appears ‘blank’ when first opened.

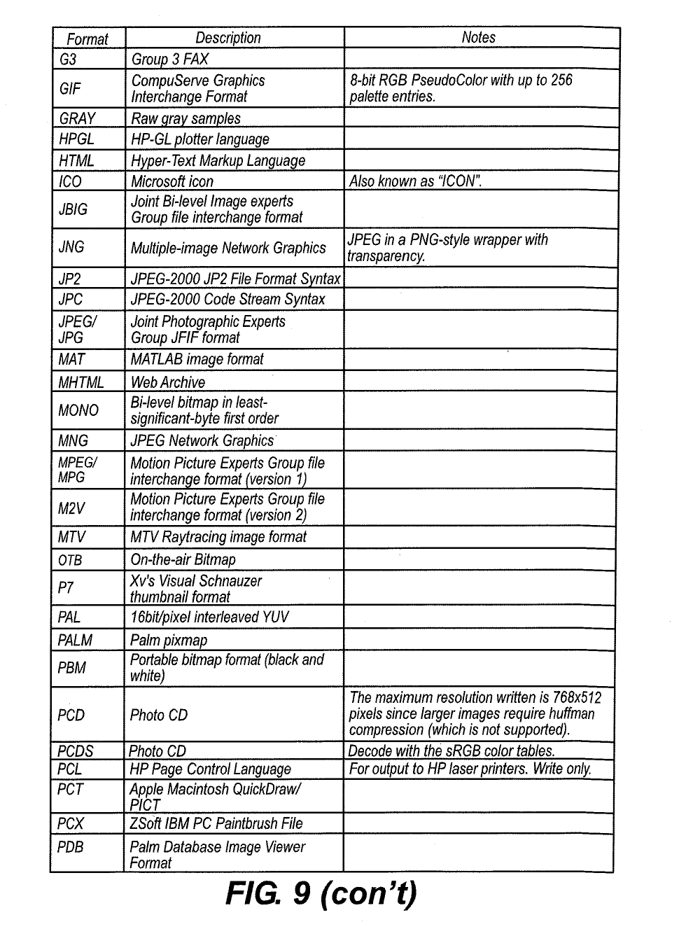

FIG. 10 depicts an illustration of the blanking process. To the left is the lead sheet 145 and payload 146 in a visible state. To the right is a visual representation of how the locked electronic document 144 would appear to a recipient prior to unlocking the document.

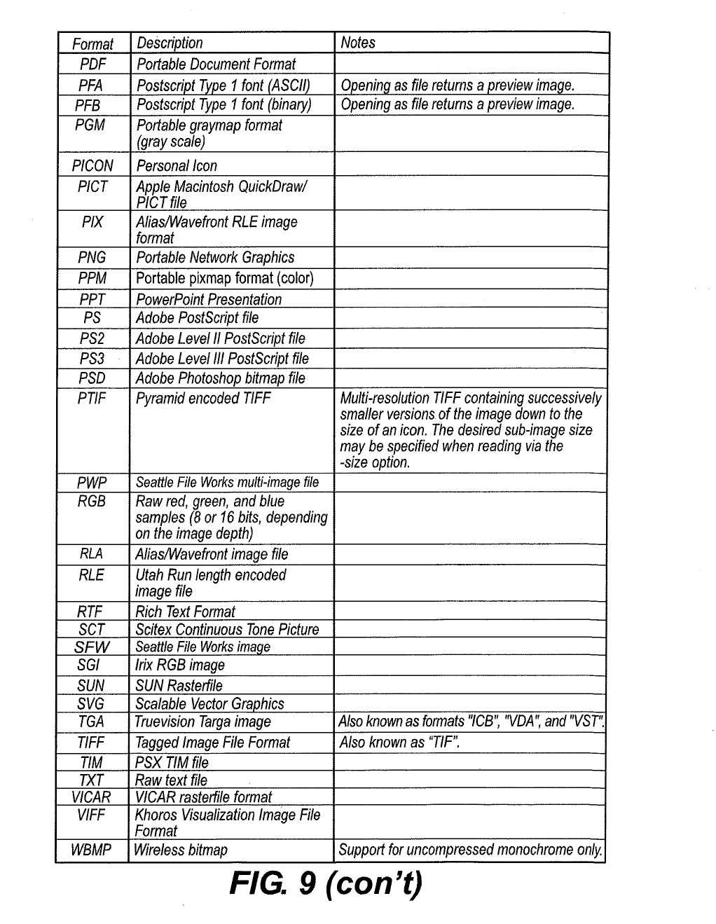

FIG. 11 depicts an exemplary graphical user interface or shipment form 158 to assist a sender in entering data such that steps 504, 506, and 508 of the method 500 may be carried out. The shipment form 158 includes input fields noted above such as Recipient Email Address Field 151; the Message Box 149; the Lead Sheet Title 148 or Shipment Name; the payload 146; and the Terms & Conditions 150.

In one embodiment, after the blanking layer 157 is applied the user may be offered optional services, such as delivery options and document options. Accordingly and referring to FIGS. 7 and 11, the step 504 of creating the locked electronic document 144 may further include the following delivery options, or optional steps in the method 500, which may be activated by selecting an appropriate field in the shipment form 158:

Send an SMS Text Message 159 with a password to open the document. This options allows the sender to create a password for the document which would need to be input by the recipient before the document could be opened. This password can be sent via SMS text, for example.

Receive SMS alert 160 when the document is opened. The sender can choose to receive an SMS text message when the recipient clicks ‘Accept’ on the document.

Receive email alert 161 when document is opened. The sender can choose to receive an email alert when the recipient clicks Accept on the document.

Send an encrypted document 162. The payload 146 may be encrypted to Federal Information Processing Standards (FIPS), specifically, FIPS 140-2 Level 2, which includes requirements for physical tamper-evidence and role-based authentication.

Allow Authorized forwarding? If the sender chooses this option, the Authorized Forwarding panel 154 will be available to the recipient on the lead sheet 145.

The step 504 of creating the locked electronic document 144 may further include the following document options or method 500 steps:

Disable Printing 163 of the document? Prevents printing of the file.

Disable Editing 164 of the document? Prevent users from copying and extracting of text or graphics, adding data, deleting, rotating pages, creating bookmarks or thumbnails, or making any other changes.

Limit the number of openings 165? The sender can set a limit on the number of times that a document can be opened.

Set Expiry Date 166? The sender can set the expiry date after which the document cannot be opened.

Other options or method 500 steps include (but not shown) adding a link to the original document. The payload document is a PDF document. If a sender uploads a Word document, for example, the conversion of this to a PDF makes it uneditable by the recipient. The sender can choose to include a button in the document that links to the original document in its original format as it was originally uploaded. This button that links to the original document is only available when the recipient has clicked the Accept Button 152.

The method 500 further includes a step 508 of sending the locked electronic document 144. In one embodiment, the sender can select the recipient from a list of existing Contacts, or create a new Contact, and designate that the locked electronic document 144 be sent to the selected Contact. When the sender positively indicates the locked electronic document 144 is ready to send, such as by clicking a ‘Send’ button, the complete shipment information is written to a record in the database. In one embodiment, there is a server process that periodically loops (e.g., once every minute) and looks for shipments that are ready to send. Below is an exemplary code for a scanning procedure:

```
(This process is automatically initiated when the web application is
launched on the 4D Server)
Search for shipments that are ready to send.
    QUERY(Shipments Ready to Send = True)
Loop around the number of shipments that are ready to send
    For (1 to Number of Shipments)
Find out if any Print, Copy or Edit options have been set
Find the Lead Sheet that goes with this shipment
Find the Payload that goes with this shipment
Find the contacts that this shipment needs to go to
Loop around the contacts that the shipment needs to go to. This
creates a unique document for each individual
    For (1 to Number of Contacts)
Set a unique file name for the secure document
Create a new PDF document and apply any Print, Copy or Edit
options that have been set for this shipment
        PDF New Object
        PDF New Document(apply the options)
Open the Lead Sheet PDF
        PDF Open PDI Document (Lead Sheet)
Find the number of pages
      PDF Get PCOS Number (Number of Pages)
Loop around the number of pages
      For (1 to Number of Pages)
Copy page into the new document
            If (This is the last page)
```

The last page is the page that needs the Accept button, email text entry field, status display field and Free Trial hyperlink button added to it. There may be a javascript attached to the Accept Button 152 which, upon activation does the following, including adding the blanking layer 157:

```
Pass the contents of the email field and the Unique ID of the
document to a SOAP method running on the 4D Server.
    var strURL = “http://serverIPaddress/4DWSDL/”;
    var service = SOAP.connect(strURL);
    var request = email entered and Unique ID
Call the Confitrack_Authorization SOAP method on the 4D Server
passing the email address and Unique ID
    var response =
    service.Confitrack_Authorization(request)
Receive a response back from the server :
        if(response == “YES”)
Change the state of the blanking layer from visible to not visible.
Change the state of the payload layer from not visible to visible.
        Else
Change the state of the blanking layer from not visible to visible.
Change the state of the payload layer from visible to not visible.
        End if
```

The 4D SOAP Server 134 may also return a status message which is shown in the ‘Display’ field. A field may be created on the PDF to display this message. If the 4D SOAP Server 134 response is YES, then the message could read, “Document unlocked and tracking commenced.” If the response is NO, then the message could be “You are not authorized to view this document.” Further, an email field may be created on the PDF so the recipient can enter their email address. Further, a button entitled ‘Free Trial’ may be added with a hyperlink to a joining page on the application website.

The following code to performs action necessary to prepare the locked electronic document 144 for shipment:

```
Close the page and the Lead Sheet :
    PDF Close PDI Page (Lead Sheet)
    PDF End Page (combined PDF)
    PDF Close PDI Document (Lead Sheet)
The next stage is to append the payload PDF :
    PDF Open PDI Document (Payload PDF)
Get the number of pages and then loop around
    PDF Get PCOS Number (“length:pages”)
    For (1 to Number of Pages)
Open the current page of the Payload document
          PDF Open PDI Page (PageNumber)
Start a new page in the combined PDF
        PDF Begin Page (combined PDF)
Create a layer called ‘payload’ with its default state set to not visible
        PDF Create Layer (payload;“defaultstate=false”)
        PDF Begin Layer (payload)
Copy the current payload page into the payload layer
        PDF Fit PDI Page
        PDF Close PDI Page
Close the payload layer
        PDF End Layer (payload)
Create a layer called ‘blank’ with its default state set to visible
        PDF Create Layer (blank;“defaultstate=true”)
        PDF Begin Layer (blank)
Insert a blank white PDF page into this layer
        PDF End Layer (blank)
End this page and move onto the next one unless this is the last
page
        PDF End Page
    End for
Close the Payload PDF and the newly created Lead Sheet and
Payload ‘combined PDF’
    PDF Close PDI Document (payload)
    PDF Close Document (combined PDF)
Move the completed PDF to a folder called ‘livecycle’
    MOVE DOCUMENT(combined PDF;livecycle)
Delay the whole process for a minute before it looks again for any
new shipments
    DELAY PROCESS(Current process;60*60)
```

The livecycle folder is a watched folder. The Accept Button 152 in a document makes a SOAP request to the hosted application 118 in order to ascertain if the recipient has the permissions to unblank the payload pages.

SOAP requests are not supported by Adobe Acrobat Reader unless the Reader Extensions have been added using the Adobe LiveCycle® Reader Extensions ES2 module to activate the SOAP functionality within Adobe Reader. Once the extension has been activated the PDF will be able to use the SOAP call on the Accept button from within Adobe Reader.

The application server 128 may include an installation of Adobe LiveCycle® ES2 installed. This has an application that runs and monitors the livecycle folder. When the combined PDF is moved into this folder it applies the Reader Extension that allows the PDF to access the SOAP method published by the 4D SOAP Server. Once the Reader Extension has been applied the complete PDF is moved to a folder called ‘processed.’ The shipment record is updated to indicate that the PDF is complete and ready to be sent.

The method 500 for creating and delivering a locked electronic document includes a step 508 to send the locked electronic document 144. In one embodiment of the invention, once the document has been created, the sender can select to whom the document is to be sent from a contact management function within the hosted application 118. In one example, a unique electronic document with a unique embedded identifier can be created for each recipient based on the selections the sender chooses in the creation of the document.

In one example, the document is sent using the hosted application 118 via email as an attachment to each of the selected recipients. Once the recipient has received the document they can download it to local drives, including USB flash drives, memory sticks, etc. The document can be opened by entering their email address, clicking the ‘Accept’ while online, whereupon the hosted application 118 server will be contacted for authorization to reveal the payload.

In one embodiment, there may be a process running on the hosted application 118 called SendMail, that automatically runs when the web application is launched, in a loop, delayed by one minute that checks shipment records for completed processed PDFs that are ready to send. When it finds a shipment that has completed processing the PDFs it may create an email for each of the designated recipients and send a personalized email, such as that shown in FIGS. 8A and 8B, with the PDF attached.

The locked electronic document 144 shipments may be sent via email. The recipient may receive a notification email with an attachment to open. In the illustrated example, the attachment is the PDF document 144 created in steps 504 and 506. In one embodiment of the invention, the recipient opens the PDF document 144 directly within the email. In another embodiment, such as when the recipient is using a local computing device 125A such as mobile device (FIG. 3) that doesn't support Adobe Reader, the email may provide a hyperlink which takes the recipient to the contents of the shipment. Both scenarios will be discussed below.

If the recipient is using a local computing device such as mobile device that doesn't support Adobe Reader, the email may provide a hyperlink which takes the recipient to the contents of the shipment. When a recipient clicks the hyperlink they are taken to a browser based form which has all the elements and general look and feel of the standard PDF Lead Sheet. The 4D Web Server will know that this page has been served and be able to record IP address, browser type and the request made of the server at this stage. This information is added to the tracking record for this shipment.

In order to view the payload the recipient will need to fill in their email address and then click the ‘Accept’ button. The click of the ‘Accept’ button runs a process within the Web Application called Confitrack_Authorization_Web. This process determines whether or not the recipient is authorized to look at the payload of the document.

The two parameters passed to the Confitrack_Authorisation_Web process are UniqueID and email address. The UniqueID parameter is used to look up the original shipment details as set up by the sender. This allows various items relating to the shipment to be checked and a decision is made as to send back a YES or a NO as to whether the recipient has the authorization to view the payload. By way of non-limiting example, items that are checked could include: whether or not the document has been frozen or vaporized (discussed below); whether or not there is an expiry date set for the document and, if so, is the current date greater than the expiry date; whether or not there is a limit to the number of openings of this document and has that limit been reached; whether or not the email address matches an email address on the distribution list for this shipment; and whether or not the email address has to match an email address in the distribution list or has the sender allowed anyone to open the document. The ‘Confitrack_Authorization_Web’ process evaluates all these conditions and sends a response to the Lead Sheet web page. The response consists of two elements: A YES or a NO and also a Status Message which is displayed within the web page. In addition, the Confitrack_Authorisation_Web process may look at whether the shipment requires any email or SMS notifications to be sent to the sender of the document to tell them that shipment has had the ‘Accept’ button clicked. All this information can be written to a tracking record associated with the PDF.

If the response is a YES, then the next page of the document is displayed in the browser. These pages can be PNG images of the PDF which were created in the Payload Creation Process (step 504). This allows them to be displayed within any browser on mobile devices or any browser capable of displaying images. There can be navigation that lets the recipient move between pages within the payload of the shipment.

If the response is a NO, then a page is displayed informing the recipient that they don't have the authorization to view the shipment at this stage.

When the recipient opens the PDF attachment 144 from within the email, the lead sheet 145 is the first page. At this stage, all subsequent pages are blanked out and appear as blank white pages, as illustrated in FIGS. 8B and 10. The Terms & Conditions Button 150 is added to the lead sheet 145 if the sender has chosen to upload a Terms & Conditions document. A hyperlink is added to the Terms & Conditions button that opens the Terms & Conditions document.

The method 500 for creating and delivering a locked electronic document includes a step 510 to validate the recipient's identity. In one embodiment, the recipient must enter their email address in the Recipient Email Address Field 151 as a measure of security that the document 144 is being opened by an authorized party. As noted above, the sender first entered this information when creating the lead sheet at step 504, and the recipient must match it to complete the validation process.

The recipient then indicates they are ready to unlock the document 144, in this example by pressing the Accept Button 152. The Accept button 152 may have an action associated with it which checks for the correct recipient email address and the correct unique identifier, or unlock code, created by the sender. If these two items are present and correct, the method 500 further includes a step 512 to remove the blanking layer. In one example, the visibility attribute of the payload layer and the blanking layer 157 are switched so the payload layer becomes visible and the blanking layer becomes not visible, thus revealing the locked content. The layer that contains the locked content can also have watermarks applied to every page which could be company logos, text or the unique tracking ID associated with the document.

In one exemplary realization of steps 510 and 512, clicking on the Accept Button 152 will execute a javascript that firstly passes the contents of the email field and the Unique ID of the document to a SOAP method running on the 4D Server (if the email field is blank, the recipient receives an Adobe Acrobat alert box to indicate that they must fill in an email address):

```
    var strURL = “http://serverIPaddress/4DWSDL/”;
    var service = SOAP.connect(strURL);
    var request = email entered and Unique ID
Call the Confitrack_Authorization SOAP method on the 4D Server
passing the email address and Unique ID
    var response =
    service.Confitrack_Authorization(request)
Receive a response back from the server :
        if(response == “YES”)
Change the state of the blanking layer from visible to not visible.
Change the state of the payload layer from not visible to visible.
        Else
Change the state of the blanking layer from not visible to visible.
Change the state of the payload layer from visible to not visible.
        End if
```

The preceding ‘Confitrack_Authorization’ SOAP method runs on the 4D SOAP Server 134. It listens for a SOAP request. When it receives a request, it processes that request and sends back the appropriate response. An incoming SOAP request from the Accept Button 152 on the PDF 144 will firstly invoke the ‘On Web Authentication’ method of the 4D Web Server. At this stage the IP Address, browser type, and the type of request the incoming connection is making can be determined. The IP Address and browser type information is recorded and the SOAP request passed onto the 4D SOAP Server 134. The two parameters passed to the Confitrack_Authorization method are UniqueID and email address. The UniqueID parameter is used to look up the original shipment details as set up by the sender. This allows various items relating to the shipment to be checked and a decision made as to send back a YES or a NO as to whether the recipient has the authorization to open the document.

Decision items may include the following: Is there an expiry date set for this document and if so is the current date greater than the expiry date? Is there a limit to the number of openings of this document and has that limit been reached? Does the email address match an email address on the distribution list for this shipment? Does the email address have to match an email address in the distribution list or has the sender allowed anyone to open the document? The Confitrack_Authorization process can evaluate all these conditions and send a response to the PDF 144. The response consists of two elements: A YES or a NO, and also a Status Message which is displayed on the PDF 144. In addition, the Confitrack_Authorization process looks at whether the shipment requires any email or SMS notifications to be sent to the sender of the document to tell them that their PDF 144 has had the ‘Accept’ button clicked.

All this information is written to a tracking record associated with the PDF 144. If the response from the server is to allow the opening of the document, then the rest of the document is unblanked and the content revealed.

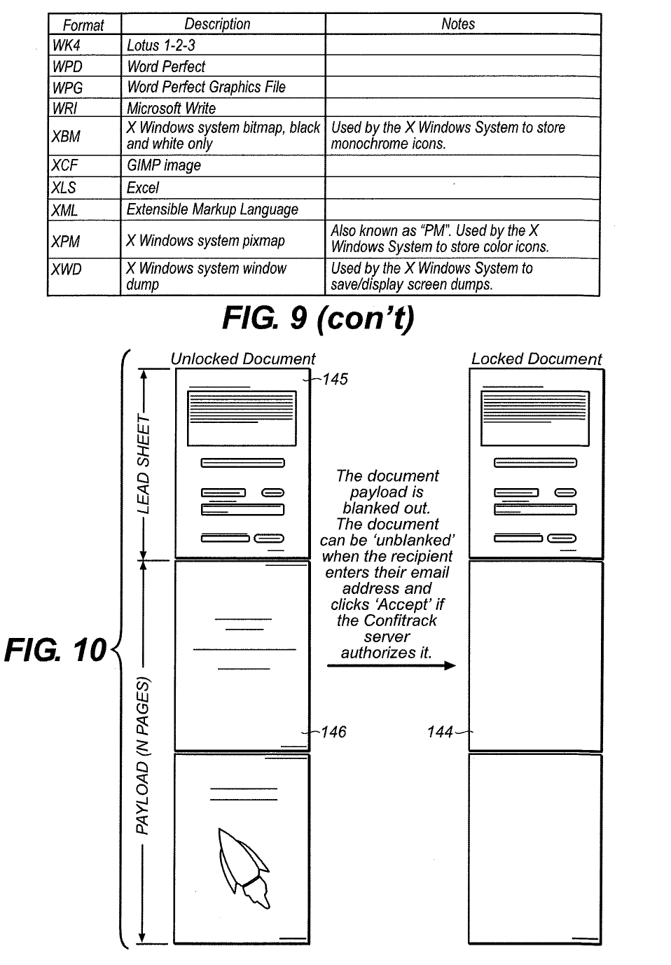

Referring briefly back to FIG. 4, the method 500 for creating and delivering a locked electronic document may include a step 514 to track the document. In one embodiment of the invention, the system 129 further includes a tracking module 167, wherein a sender can track the progress of their shipments, such as clicking on an ‘eTrack’ button 168, for example (FIG. 5). Within the tracking module 167, the sender can be presented with a chronological list (e.g., most recent at the top) of all the shipments they have made. An exemplary illustration of a tracking screen 169 or graphical interface displaying information in the tracking module is shown in FIG. 12. The tracking screen 169 can display the shipment names 148, which were defined as the lead sheet title; the shipment dates corresponding to the dates the shipments were sent; and a hyperlink to the lead sheet 145 associated with the shipments. Clicking the link bring up the lead sheet 145 in a new window, in one example. The tracking screen 169 can further include a hyperlink to the secured document 146 or payload that was included within the shipment. In on example, clicking the link brings up the secured document 146 in a new window.

The tracking screen 169 can further include a ‘Track It’ button 170 to take the sender through the detailed shipment history relating to the selected shipment. Further included on the tracking screen 169 may be a ‘Freeze’ feature 171 that allows the shipment to be locked and unable to be opened by recipients. When activated, this freeze module 171 overrides all the current shipment settings. In one example, the freeze feature 171 can be activated on the shipment as a whole. In another example, the freeze feature 171 can be activated on an individual basis. On an individual basis, the sender can select from a list of recipients (e.g., 151 on FIG. 7) and set the blanked part of the shipment 144 to be unopenable for them. In one example, the recipient clicks on the ‘Accept’ button 152 on the lead sheet 145 and they will get a response from the server to say that the shipment is now locked and cannot be opened by the recipient. These settings can also be applied instantly to the shipment as a whole, so all recipients of the shipment no longer have access to the content. The shipment can subsequently be reset, per individual or as a whole, and set to be openable again.

The tracking screen 169 can further include a link to a ‘Vaporize module’ 172 that allows the sender to instantly stop access to the document forever, fully and finally. In addition, the tracking screen 169 can further include an end date indicating at what future date tracking of the shipment is to be ceased.

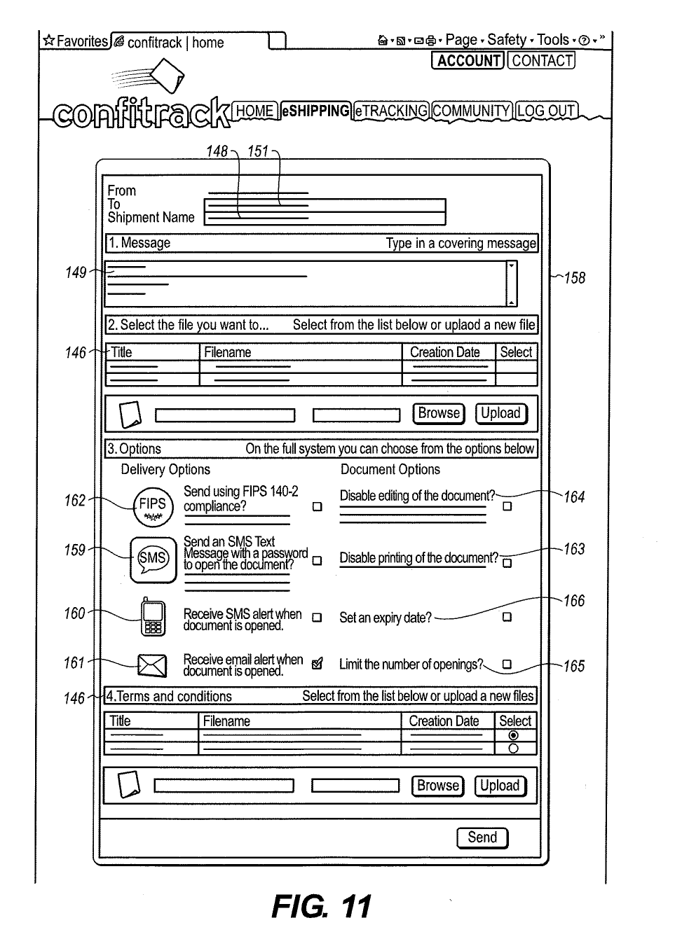

Turning to FIG. 13, as noted above, the tracking module 167 may include a Shipment History screen 173 to bring up a visual report of the shipment history. The shipment history screen 173 can show the shipment details and the history of the shipment. In one embodiment of the invention, the shipment history screen 173 can include information such as Shipment Name 148, which is the name of the shipment given by the sender in the lead sheet 145; Shipment Date, which is the date the shipment was sent (shipment time can be included); End Date, indicating at what future date tracking of the shipment is to be ceased; a hyperlink to the lead sheet 145 associated with the shipment; a hyper link to the Secured Document 146 (e.g., payload); the Unique Tracking ID 156 associated with each document sent; the email address 151 of the original recipient to which the Secured Document 146 was sent; Document action 174, which may show the actions the recipient has carried out on the document, i.e., clicked the ‘Accept’ Button 152, clicked the ‘Terms and Conditions’ Button 150, clicked the ‘Authorized Forward’ Button 155, to name a few examples. The shipment history screen 173 may also display the email address 151 that the recipient entered to unlock the electronic document 144; the date and time at which any document action was performed; and the recipient IP Address 175 and recipient Region 176 at which any document action was performed. The Region 176 information may be gathered from a third party organization 142C such as HostIp.info (noted above), and correlated to an icon of a country flag denoting the region.

The shipment history screen 173 may further include an authorization status 177 for each recipient. In one example, a shipment can be set up in two ways regarding the distribution of the shipment. In the first way, the authorization status 177 can include an indicator, such as a green check mark, indicating the shipment can be set to only allow authorized openings. In the second way, the authorization status 177 can include an indicator, such as a red ‘X’, indicating the shipment can be set to allow anyone to open it.

The green check mark could indicate that the shipment can only be opened if the recipient enters an email address that is on the original recipient list when the shipment was sent out by the sender. If the email address entered on the lead sheet 145 doesn't match an email address on the shipment distribution list, the document content cannot be unlocked. This activity can be monitored and tracked by the hosted application 118 and, if the email address does not match, an indicator such as a green cross could be displayed.

The red ‘X’ could indicate that the shipment is Unauthorized and can be set to allow anyone to open it. By way of example, the shipment is initially sent to the recipients on the shipment distribution list but after that any email address entered on the lead sheet will allow the document content to be unlocked. This activity is still monitored and tracked by the server and a red cross is displayed against these openings.

In another embodiment, if the sender includes the ‘Authorized Forwarding’ feature 154 within their lead sheet 145, then any document openings associated with the authorized forwardings are recorded as a separate Document Action 174 entitled ‘Authorized Forwarding’ and, in one example, an indicator such as a blue dot is displayed rather than a check mark or an ‘X’. These ‘Authorized Forwardings’ can be related back to the original document from which they were passed on.

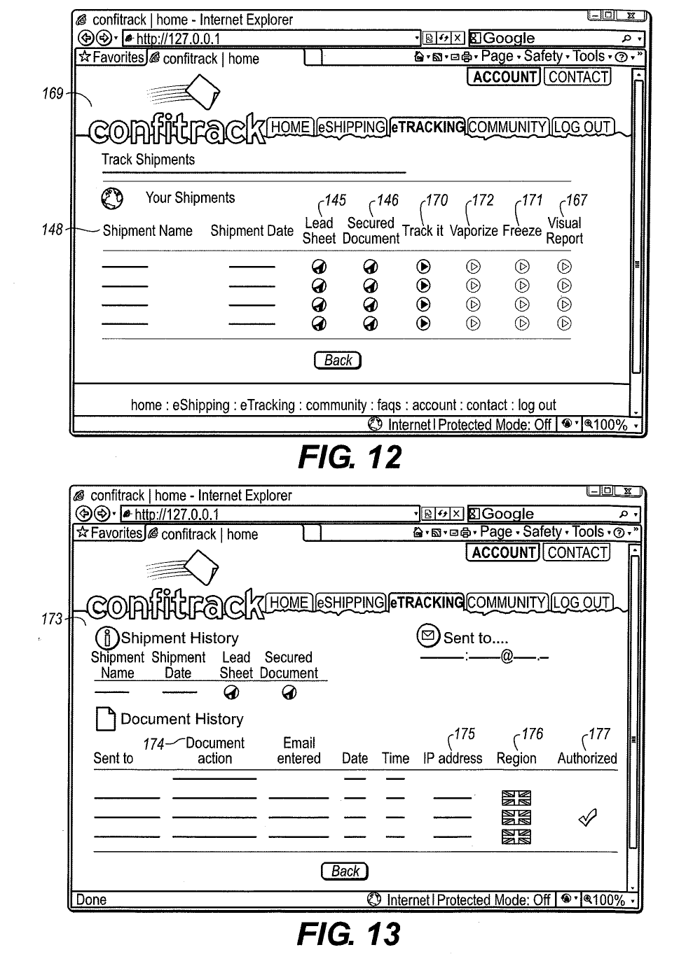

FIG. 14 illustrates an alternate embodiment of a tracking module shipment history screen 273 in which the sender is presented with a graphical hierarchical history of each of the document transmissions. The tiered approach is useful in that it provides the original sender a quick visual display of the chain of custody for each document sent. In one embodiment of the invention, the document sender has an authenticated logon to the hosted application server. The sender can monitor the documents that they have sent. In one example, the sender may track the following information recorded from a document: the date and time when a recipient clicks the “Accept” button; the email address entered; the IP address of the recipient upon clicking on any of the document buttons (thereby allowing GeoTagging of the document); the email address used for Authorized Forwarding; and the date and time when a recipient clicks the “Forward” button.

In the illustrated embodiment of FIG. 14, a top level 278 of the hierarchy displays relevant sender information. Underneath, a second level 279 displays the ‘Level 1’ recipients 280, that is, those who received the locked electronic document 144 directly from the sender. Below that, a third level 281 displays ‘Level 2’ recipients 282 corresponding to those that received the document 144 from a party to the second level. The hierarchy may continue for as many levels are required to display the entire chain of custody. In the illustrated example, a final fourth level 283 displays ‘Level 3’ recipients 284 corresponding to those that received the document 144 from a party to the third level.

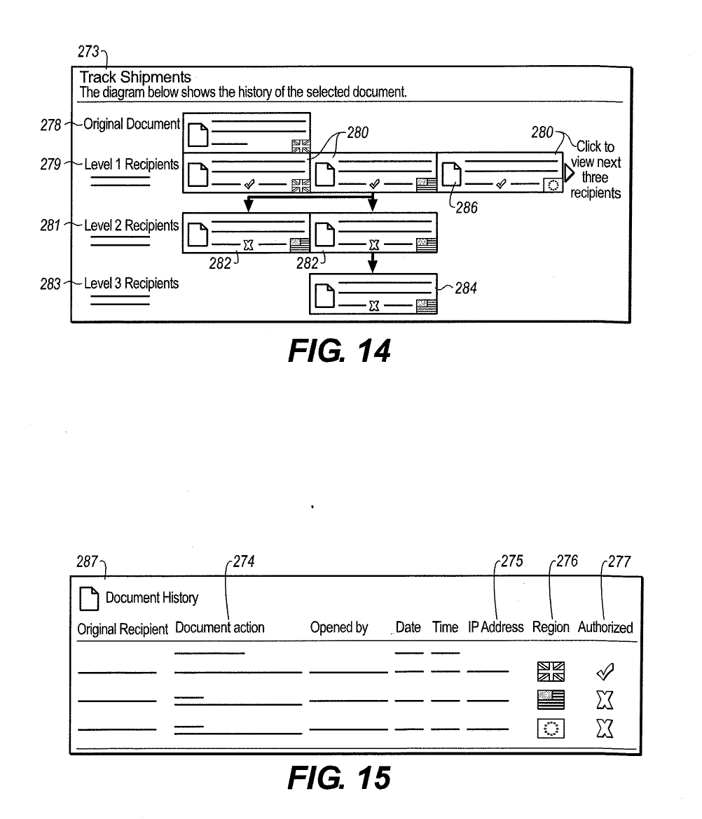

Each graphical display corresponding to the ‘Level X’ recipients may include a Document History module 285 attached thereto, graphically illustrated as a document history icon 286. Selecting the document history icon 286 may bring up a Document History screen 287 within the Document History module 285. FIG. 15 illustrates one possible embodiment of the Document History screen 287. The information contained therein may contain some of the information embodied in the shipment history screen 173 illustrated in FIG. 13, albeit displayed in a manner to more easily track the history of the particular recipient. For example, the Document History screen 287 may include: the Original Recipient, similar to the ‘Sent To’ column in FIG. 13; the Document Action 274; Opened By, including date and time; the IP Address 275 of the recipient; the Region 276 from which the recipient opened the document, and the recipient authorization status 277.

In addition to tracking the document throughout its lifecycle, the sender can lock a sent document and deny access to the document at any time. The sender can also dynamically put an expiration date on the document so the document cannot be opened after a specified date, and may further limit the number of openings of the document.

If the recipient is using a mobile device 125A, in one embodiment there may be mobile application software, or app 188, that can be downloaded for iOS, Android, BlackBerry™ and Tablet OS devices and all current and emerging operating systems and devices. Once the app 188 had been installed it can run in the background and poll the hosted application 118 periodically and alert the recipient when any new documents have been sent to them. The recipient can then open them directly via their app 188 rather than using the details sent in the email. In one example, the app 188 opens the lead sheet 145 of the document. The recipient then enters their email address and clicks the Accept Button 152. The document payload 146 is then revealed. This process allows full tracking of the document by the document originator as outlined in the tracking process above.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A system for creating and delivering a locked electronic document in a computing environment, comprising:
a computer readable system memory comprising at least one program module;
a bus coupled to the computer readable system memory;
a processor coupled to the bus; and
program instructions, stored on the system memory for execution by the processor, to:
create a lead sheet having a unique embedded identifier,
add a payload to the lead sheet to form the electronic package;
add a blanking layer to the electronic package to obscure the payload from view of a recipient;
send the electronic package in the computing environment to a designated recipient;
validate the designated recipient's identity; and
remove the blanking layer in response to validating the designated recipient's identity, thereby allowing the recipient to view the payload.

2. The system according to claim 1, wherein the program instructions are provided as a service in a cloud computing environment.

3. The system according to claim 1, wherein the program instructions validate the recipient's identity by comparing an email address input by the recipient to an email address stored on the system memory by a sender and, if the two email addresses match, granting access to the payload.

4. The system according to claim 1, wherein the program instructions validate the recipient's identity by comparing a unique identifier embedded in the lead sheet of the received locked electronic document to a unique identifier stored on the system memory by a sender and, if the two identifiers match, granting access to the payload.

5. The system according to claim 1, wherein the program instructions track the payload.

6. The system according to claim 5, wherein the program instructions acquire an Internet Protocol address of the recipient and correlate the Internet Protocol address to a geographic region.

7. The system according to claim 6, wherein the program instructions utilize geotracking to establish the geographic region of the recipient.

8. The system according to claim 1, wherein the program instructions to add the blanking layer comprise overlaying the blanking layer on the payload, the blanking layer having a visibility attribute set to visible, and the payload having a visibility attribute set to not visible.

9. The system according to claim 8, wherein the program instructions to remove the blanking layer comprise setting the visibility attribute of the blanking layer to not visible, and setting the visibility attribute of the payload to visible.

10. The system according to claim 8, wherein the blanking layer comprises an opaque white layer.

11. A method for creating and sending by a sender a locked electronic document and delivering the locked electronic document to a recipient in a computing environment, the method comprising the steps of:
creating a locked electronic document comprising a lead sheet and a payload, the lead sheet having a unique identifier for the locked electronic document;
adding a blanking layer to obscure the payload from view of the recipient;
sending the electronic package in the computing environment to a designated recipient;
validating the recipient's identity to assure the recipient of the electronic package is the designated recipient; and
removing the blanking layer in response to validating the recipient's identity, thereby allowing the recipient to view the payload.

12. The method according to claim 11, further comprising the step of tracking the electronic package by the sender.

13. The method according to claim 12, wherein the step of tracking the electronic package comprises acquiring the recipient's Internet Protocol address and correlating the Internet Protocol address to a geographic region.

14. The method according to claim 11, wherein the step of validating the recipient's identity comprises the steps of password-protecting the electronic package, and providing a password key to the recipient by a separate delivery method.

15. The method according to claim 11, wherein the step of validating the recipient's identity comprises matching a unique identifier embedded in the lead sheet of the received locked electronic document to the same identifier stored by the sender on the system memory.

16. The method according to claim 11, further comprising the step of authorizing a recipient to forward the locked electronic document to a second-tier recipient.

17. The method according to claim 16, further comprising the step of maintaining a chain of custody by compiling an authorization status for all recipients of the locked electronic document.

18. The method according to claim 11, wherein the step of creating the locked electronic document comprises retaining a native version of the payload and converting a copy of the payload to a common format for sending.

19. The method according to claim 18, wherein the common format is a PDF file format.

20. A computer program product for creating and delivering a locked electronic document in a computing environment, comprising:
a computer readable storage device having computer readable program instructions embodied therewith, the program instructions configured to:
create a lead sheet having a unique embedded identifier;
add a payload to the lead sheet to form the locked electronic document;
add a blanking layer to the locked electronic document to obscure the payload from view of a recipient;
send the electronic package in the computing environment to a designated recipient;
validate the designated recipient's identity;
remove the blanking layer in response to validating the designated recipient's identity, thereby allowing the recipient to view the payload; and
track the payload by acquiring an Internet Protocol address of the recipient and correlating the Internet Protocol address to a geographic region.
